(19) United States
(12) Patent Application Publication
(10) Pub. No.: US 2017/0132379 A1
(43) Pub. Date: May 11, 2017

(54) System and Method for Improving the Rate of Prescription, Accessibility, and Functionality of Asthma Action Plans

(71) Applicant: Medic Apps, LLC, Knoxville, TN (US)

(72) Inventors: Jeffrey Gotcher, Maryville, TN (US); Laura Odom, Knoxville, TN (US)

(21) Appl. No.: 15/344,721

(22) Filed: Nov. 7, 2016

Related U.S. Application Data
(60) Provisional application No. 62/251,750, filed on Nov. 6, 2015.

(51) Int. Cl. G06F 19/00

(52) U.S. Cl. CPC G06F 19/325; G06F 19/3406; G06F 19/3456

(57) ABSTRACT

A system for prescribing a real-time asthma action plan to a patient includes a database and modules implemented on the database for prescribing an asthma action and control plan. The system receives data regarding a patient user's best peak flow measurement from the patient user through an interface module, data regarding asthma medications of the patient user from a healthcare provider user, and data regarding asthmatic triggers of the patient from the healthcare provider user. The system stores data received from the patient user and the healthcare provider user on a healthcare information database. The system receives data regarding a patient user's current respiratory condition from the patient user through an interface and generates patient user specific instructions based on the received data regarding the patient's user's best peak flow measurement and healthcare provider user medication data in response to the patient user's current respiratory condition.

### CROSS-REFERENCE TO RELATED APPLICATION

This application claims priority to U.S. Provisional Patent Application No. 62/251,750 entitled “System and Method for Improving the Rate of Prescription, Accessibility, and Functionality of Asthma Action Plans,” which was filed on Nov. 6, 2015, the contents of which are incorporated herein by reference in its entirety.

### FIELD

This invention relates to the field of asthma treatment and prevention. More specifically, the invention of the present disclosure relates to a system and method of improving the rate of prescription, accessibility, and functionality of a written asthma action care plan to increase the likelihood of access and adherence to the action care plan in the event of asthma exacerbation.

### BACKGROUND

Asthma is a chronic disease of the airways marked by recurrent episodes of coughing, wheezing, tightness in the chest, and shortness of breath. According to the Centers for Disease Control, asthma is a significant public health problem in the United States. The incidence of asthma has increased by 15% over the last decade. It is estimated that approximately 18.7 million adults and 7 million children had asthma in 2010. Between 2001 and 2009 alone there was a 12.3% increase in the prevalence of asthma. Despite improved pharmacological treatment options such as monoclonal antibodies and new inhaled corticosteroid options, the rate of asthma exacerbations is increasing. In 2011, 3 out of 5 children with asthma experienced recurrent asthma symptoms.

Asthma burden affects mortality, morbidity, quality of life, and the economy. Asthma caused more than 3,300 deaths in the United States in 2011, and the death rate among children under the age of 19 has increased by 80% since 1980. Furthermore, there were an additional 7,000 deaths in which asthma was listed as a contributing factor. A recent publication in the British Medical Journal found that two thirds of deaths from asthma are preventable. The report cited the importance of “personal asthma plans for patients, timely reviews of asthma care, and the prescription of more appropriate drugs.”

Asthma exacerbations result in approximately 2 million emergency department visits each year, representing approximately 25% of the total number of emergency room visits. Asthma is the third most common cause of hospitalizations in children under the age of 15. Asthma is also the leading cause of school absenteeism, resulting in more than 13 million total missed days. Patients with asthma experience symptoms of frequent coughing, wheezing, shortness of breath, and tightness in the chest. Children with frequent asthma symptoms spend less time running, playing, and participating in sports.

The direct cost of asthma care increased from $46.8 billion to $50.1 billion between 2002-2007. Indirect costs of asthma, such as lost productivity, are estimated to be an additional $5.9 billion. One of the most significant costs associated with asthma is prescription therapy. It is estimated that the average cost per patient to treat asthma annually is approximately $3000. At this time, there are no generic asthma inhalers available on the market. This is in part due to the recent conversion of all Chlorofluorocarbon (CFC) propellant inhalers to the environmentally friendly Hydrofluoroalkane (HFA) inhalers. Due to this change, the few generic inhalers available are no longer available, and the new inhalers are name brand and more costly. As a result, many patients will reduce the use of their medications in order to save money.

Adolescents are at a particular risk of the morbidity associated with asthma. An adolescent is traditionally considered someone between the ages of 12-19. Approximately 12% of high school students had a diagnosis of asthma in 2011. Psychosocial issues, such as low self-esteem, pose a possible problem with medication adherence due embarrassment using an inhaled device. Due to this social anxiety, some common behavior seen among adolescents includes the tendency to ignore symptoms and to restrict activity rather than using inhalers to control symptoms.

Asthma burden is expanding, and the impacts of asthma are far reaching. The burden of asthma affects individuals and communities, and the disease is a global problem. An effective way to reduce asthma burden may be to increase the perceived level of control among patients with asthma. This involves a multi-faceted plan that must include disease education. Patients need to understand the disease and importance of management in order to reduce their exacerbation rate. Patients should be aware of their triggers for asthma symptoms as well as what to do in the event of an exacerbation.

There is evidence to support that patients are often poor perceivers of their level of control. A web based survey of 1,812 patients compared patient perception to an objective measure of control and found that approximately 70% of patients felt that they had adequate control of their symptoms. However, in reality, only 30% of these same patients were considered controlled as defined by National Heart, Lung, and Blood Institute (NHLBI) guidelines. Thus, there is a need to educate patients more specifically about their level of asthma control as well as how to better control their symptoms.

Written asthma action plans are standard of care according to national guidelines, but unfortunately, these plans are often not done. Once the provider creates a written action plan, it is the patient's responsibility to have access to the plan in the event of an exacerbation. Unfortunately, there are instances in which a patient misplaces the written action plan. Specifically regarding adolescent patients, it is possible that the patient might feel embarrassed to admit symptoms of an asthma exacerbation. This might create a situation in which the patient would be even less likely to have access to their action plan and an inhaled beta agonist (rescue medication) available.

In light of the above, there is a need for a system and method of improving the rate of prescription, accessibility, and functionality of a written asthma action care plan to increase the likelihood of access and adherence to the action care plan in the event of asthma exacerbation. Further, there is a need for a system and method of providing an asthma action care plan that is user friendly, requires minimal time to operate, and that is practice and age appropriate.

### SUMMARY

There are five issues the present disclosure seeks to address. These issues relate to (1) improving patient care for asthma sufferers; (2) enabling healthcare providers to monitor a patient's asthma control in real-time; (3) simplifying insurance reimbursements by automatically documenting patient education; (4) meeting the requirements of meaningful use of technology in practice for Medicare and Medicaid incentive programs; and (5) providing pharmaceutical and insurance companies with prescription data in a way that is both HIPAA and HITECH Act compliant.

The present disclosure seeks to improve patient care in asthma patients by employing a system and method to:

a) increase the rate of asthma action plans prescribed to patients during office visits;

b) improve patient access to asthma action plans at the time of an exacerbation; and

c) improve upon the functionality of written asthma action plans currently in place.

The present disclosure enhances the ability of healthcare providers to monitor their patients' asthma control in real-time by opening and maintaining a line of communication between patients and their doctors that extends beyond the confines of the doctor's office. Providers may view their patients' Asthma Control Test scores at any time, and are alerted when one of their patient's asthma is not being controlled. This creates an opportunity to interact with patients that is impossible using written asthma action plans alone.

The system and method of the present disclosure allows providers to easily document patient education, thus simplifying insurance reimbursement by reducing the time and expense presently incurred by practices with respect to this process.

The use of the present disclosure to improve the quality and efficiency of patient care meets the requirements of meaningful use within the context of the Medicare and Medicaid electronic health record (“EHR”) incentive programs.

Finally, the present disclosure addresses a system and method for scrambling PHI data stored within a HIPAA and HITECH-compliant database, so that the scrambled data, stripped of any personally identifiable health information, can then be stored, manipulated, and exported as non-PHI data for transmission to third party vendors such as insurance and pharmaceutical companies for marketing and other business intelligence purposes.

In a first aspect, a system for prescribing a real-time asthma action plan to a patient is provided. The system includes a database having at least one processor and at least one computer readable storage medium in communication with the processor and instructions stored on the at least one computer readable storage medium for implementing a plurality of modules for prescribing an asthma action and control plan, the plurality of modules including an interface module and an asthma action plan module. The interface module includes a graphical user interface for providing visual and textual information to and receiving data entry input from a plurality of users. The asthma action plan module receives data regarding a patient user's best peak flow measurement from the patient user through the interface module; receives data regarding any controller zone, quick relief zone, and alert zone medications of the patient user from a healthcare provider user; receives data regarding asthmatic triggers of the patient from the healthcare provider user; stores data received from the patient user and the healthcare provider user on a healthcare information database; receives data regarding a patient user's current respiratory condition from the patient user through the interface module; generates patient user specific instructions based on the received data regarding the patient's user's best peak flow measurement and healthcare provider user medication data in response to the patient user's current respiratory condition; and displays the generated patient user specific instructions to the patient on the interface module.

In one embodiment, the system also includes a classifying asthma severity test module that displays a plurality of prompts to the patient user regarding asthma symptoms of the patient user; displays a plurality of patient user selectable responses to the plurality of prompts to the patient user on the interface module; receives data regarding responses to the plurality of prompts selected by the patient user; stores data related to the plurality of received responses to the plurality of prompts selected by the patient user; assigns each of the plurality of received responses a value based on a severity of the patient user's asthma symptoms; generates a classifying asthma severity test score based on the values of the plurality of received responses of the patient user; and displays the generated classifying asthma severity test score to the patient user on the interface module.

In another embodiment, the classifying asthma severity test module transmits a notification to the healthcare provider user regarding a status of the patient user's asthma symptoms when the generated classifying asthma severity test score is beyond a designated threshold.

In yet another embodiment, the classifying asthma severity test module generates a periodic notification that is transmitted to the patient user to perform a test of the patient user's asthma severity.

In one embodiment, the plurality of prompts displayed to the patient user correspond to a number of times that the patient user's asthma symptoms required use of a medicine, a level of severity of asthma symptoms of the patient user, whether the patient user experienced symptoms that awoke the patient user from sleep, and a number of current asthma symptoms being experienced by the patient user.

In another embodiment, the system includes a peak flow meter in electronic communication with the database, wherein data regarding the patient user's current respiratory condition is received from the peak flow meter and stored on the healthcare information database.

In yet another embodiment, data regarding the patient user's current respiratory condition is transmitted to the healthcare provider user.

In one embodiment, the system also includes a data export module that generates non-personally identifiable healthcare data by removing identifiable information from the patient user data from the patient user data stored on the healthcare information database and stores non-personally identifiable healthcare data on a non-personally identifiable healthcare information database.

In another embodiment, the non-personally identifiable healthcare data is tagged with one or more clearance restrictions that designate authorized data feed users.

In yet another embodiment, the data export module exports non-personally identifiable healthcare data to authorized data feed users in response to a request for healthcare data from the data feed users.

In a second aspect, a system for prescribing a real-time asthma action plan to a patient is provided including a database having at least one processor and at least one computer readable storage medium in communication with the processor and instructions stored on the at least one computer readable storage medium for implementing a plurality of modules for prescribing an asthma action and control plan, the plurality of modules including an interface module, an asthma action plan module, and a classifying asthma severity test module. The interface module includes a graphical user interface for providing visual and textual information to and receiving data entry input from a plurality of users. The asthma action plan module receives data regarding a patient user's best peak flow measurement from the patient user through the interface module, receives data regarding any controller zone, quick relief zone, and alert zone medications of the patient user from a healthcare provider user, receives data regarding asthmatic triggers of the patient from the healthcare provider user, stores data received from the patient user and the healthcare provider user on a healthcare information database, receives data regarding a patient user's current respiratory condition from the patient user through the interface module, generates patient user specific instructions based on the received data regarding the patient's user's best peak flow measurement and healthcare provider user medication data in response to the patient user's current respiratory condition, and displays the generated patient user specific instructions to the patient on the interface module. The classifying asthma severity test module displays a plurality of prompts to the patient user regarding asthma symptoms of the patient user, displays a plurality of patient user selectable responses to the plurality of prompts to the patient user on the interface module, receives data regarding responses to the plurality of prompts selected by the patient user, stores data related to the plurality of received responses to the plurality of prompts selected by the patient user, assigns each of the plurality of received responses a value based on a severity of the patient user's asthma symptoms, generates a classifying asthma severity test score based on the values of the plurality of received responses of the patient user, and displays the generated classifying asthma severity test score to the patient user on the interface module.

In a third aspect, a method for generating a real-time asthma action plan to a patient is provided. The method includes: receiving data regarding a patient user's best peak flow measurement from the patient user on a database; receiving data regarding any controller zone, quick relief zone, and alert zone medications of the patient user from a healthcare provider user on the database; receiving data regarding asthmatic triggers of the patient from the healthcare provider user on the database; receiving data regarding a patient user's current respiratory condition from the patient user on the database; generating patient user specific instructions based on the received data regarding the patient's user's best peak flow measurement and healthcare provider user medication data in response to the patient user's current respiratory condition; and displaying the generated patient user specific instructions to the patient on a patient device.

In one embodiment, the method for generating a real-time asthma action plan to a patient further includes: displaying a plurality of prompts to the patient user regarding asthma symptoms of the patient user; displaying a plurality of patient user selectable responses to the plurality of prompts to the patient user on the interface module; receiving data regarding responses to the plurality of prompts selected by the patient user; storing data related to the plurality of received responses to the plurality of prompts selected by the patient user; assigning each of the plurality of received responses a value based on a severity of the patient user's asthma symptoms; generating a classifying asthma severity test score based on the values of the plurality of received responses of the patient user; and displaying the generated classifying asthma severity test score to the patient user on the interface module.

Other objects and advantages of the invention, besides those discussed here will be apparent to those of ordinary skill in the art from the description of the preferred embodiments which follows. In the description reference is made to the accompanying drawings, which form a part hereof, and which illustrate examples of the invention. Such examples, however, are not exhaustive of the various embodiments of the invention, and therefore reference is made to the claims which follow the description for determining the scope of the invention.

### BRIEF DESCRIPTION OF THE DRAWINGS

Further features, aspects, and advantages of the invention represented by the embodiments described in the present disclosure will become better understood by reference to the following detailed description and accompanying figures, wherein elements are not to scale so as to more clearly show the details, wherein like reference numbers indicate like elements throughout the several views, and wherein:

FIG. 1 illustrates one embodiment of the high level architecture and external interfaces of a platform for practicing the method of the present disclosure;

FIG. 2 illustrates one embodiment of the various component modules of the system of the present disclosure;

FIG. 3 is a high level flow chart illustrating the various functions of the Admin and Security component modules of the system of the present disclosure;

FIG. 4a illustrates a screenshot of the Interface displaying the system's “Signup/Login” screen, while FIG. 4b illustrates a screenshot of the Interface displaying the system's “Account Registration” screen;

FIG. 5a illustrates a screenshot of the Interface displaying the system's “Settings” screen, while FIG. 5b illustrates a screenshot of the Interface displaying the System's “Help” screen;

FIG. 6 is a flowchart illustrating one embodiment of the Asthma Action Plan Module's functions;

FIG. 7 illustrates a screenshot of the Interface displaying the Asthma Action Plan Module's “Personal Best Peak Flow” screen;

FIGS. 8a, 8b, and 8c illustrate screenshots of the Interface displaying, respectively, the Asthma Action Plan Module's “Green Zone Medications,” “Yellow Zone Medications,” and “Red Zone Medications” input screens;

FIG. 9 illustrates a screenshot of the Interface displaying the Asthma Action Plan Module's “Asthma Triggers” input screen;

FIG. 10 illustrates a screenshot of the Interface displaying the Asthma Action Plan Module's “How are You Feeling?” screen;

FIGS. 11a, 11b, and 11c illustrate screenshots of the Interface displaying, respectively, the Asthma Action Plan Module's “Green Zone Instructions,” “Yellow Zone Instructions,” and “Red Zone Instructions” screens;

FIG. 12 is a flowchart illustrating one embodiment of the Asthma Control Test Module's functions;

FIGS. 13a, 13b, and 13c illustrate screenshots of the Interface displaying, respectively, the Asthma Control Test Module's “Launch,” “Test,” and “Score” screens;

FIG. 14 is a flowchart illustrating one embodiment of the Data Export Module's functions;

FIG. 15 illustrates an exemplary architecture of a computing device suitable to implement aspects of the present disclosure.

These drawings are provided to illustrate various aspects of the invention and are not intended to be limiting of the scope in terms of dimensions, materials, configurations, arrangements or proportions unless otherwise limited by the claims. Reference will now be made to the exemplary embodiments illustrated, and specific language will be used herein to describe the same. It will nevertheless be understood that no limitation of the scope of the invention is thereby intended.

### DETAILED DESCRIPTION

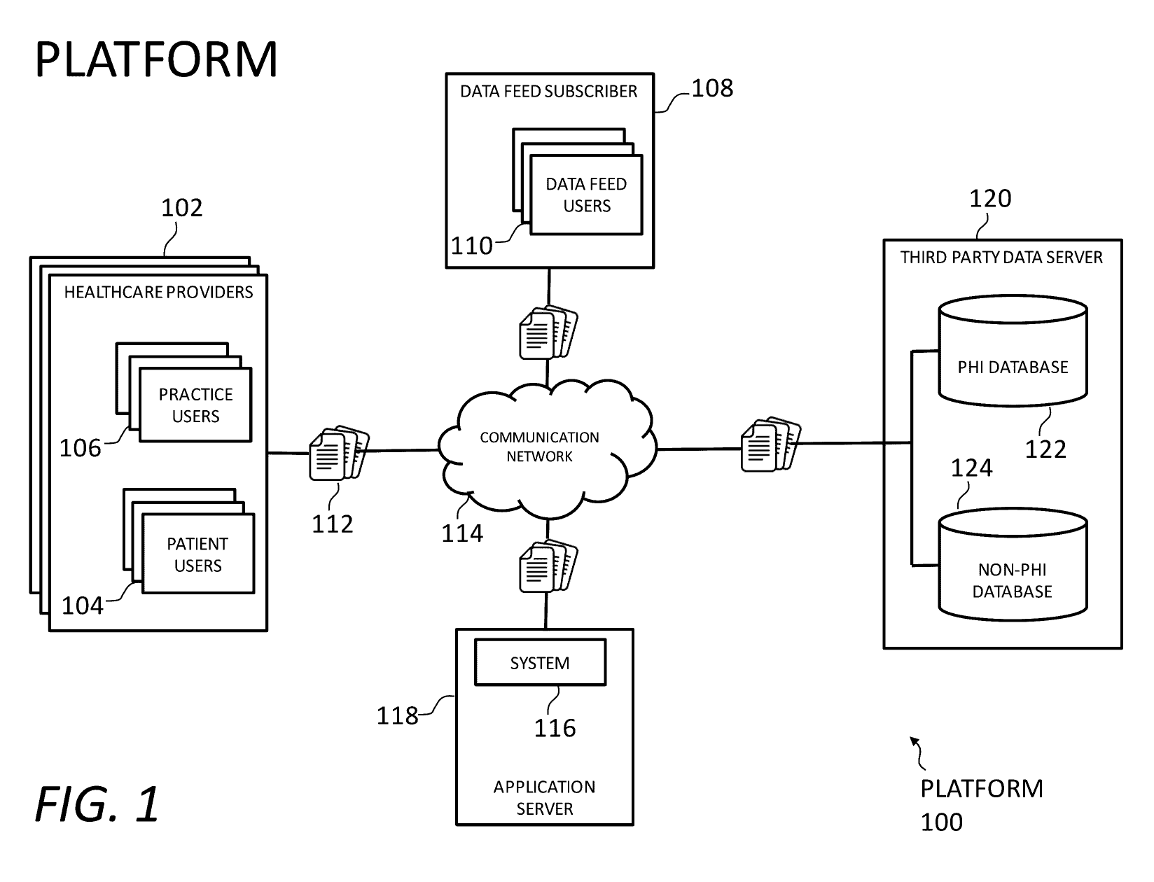

An embodiment of the present invention and its advantages are best understood by referring to FIGS. 1-15 of the drawings, like numerals being used for like and corresponding parts of the various drawings.

Referring now to FIG. 1, a high level architecture of the Platform 100 and external interfaces for a system for prescribing and improving accessibility of an asthma action plan 116 are shown.

In various embodiments, a Healthcare Provider 102 may include any individual, group of individuals, or entity that owns, controls, or manages electronic personal health information (“PHI”) relating to one or a plurality of patients, e.g., physicians, groups of physicians, hospitals, hospital systems, research institutions, etc. By way of example only, a physician's office employing a plurality of physicians, physicians' assistants, nurse practitioners, and office administrators that uses the System 116 would be considered a single Healthcare Provider 102 for purposes of the present disclosure.

In various embodiments, a Practice User 104 may include any individual employee, contractor, or agent of a Healthcare Provider 102 that uses the System 116 to either transmit, create, manipulate, or receive data, either on behalf of a Healthcare Provider 102 or on behalf of a Patient User 106, e.g., a physician, nurse practitioner, physician's assistant, office administrator, etc.

In various embodiments, a Patient User 106 includes, but is not limited to, any individual that is prescribed an asthma action plan by a Healthcare Provider 102, or any such individual's legal guardian, attorney-in-fact, or agent.

In various embodiments, a Data Feed Subscriber 108 may include any individual, group of individuals, or entity that purchases Non-PHI data exported from the System 116 for marketing or other business intelligence purposes.

In various embodiments, a Data Feed User 110 may include any individual employee, contractor, or agent of a Data Feed Subscriber 108 that uses the System 116 to receive Non-PHI data from the System 116.

As used in the present disclosure, “User” or “Users” shall refer to Practice Users 104, Patient Users 106, and Data Feed Users 110, collectively, while specific reference to a particular type of user, e.g., Patient User 108, shall only refer to that particular class of user.

In various embodiments, Data 112 may be imported to or exported from the System 116 by Users. This Data 112 may include, but is not limited to, health information of a personal, and protected nature (“PHI Data”), as well as data that either contains no personally identifiable health information, or has been stripped of any PHI Data by the System 116 (“Non-PHI Data”).

In various embodiments, Communications Network 114 may include wired telecommunications, satellite, microwave, the Internet, or other suitable wireline or wireless networks, or a combination of the preceding.

The operation of the System 116 may be conducted using software, hardware, human resources, or any combination of the preceding. The System 116 provides a means to (1) improve patient care in asthma patients; (2) enable healthcare providers to monitor a patient's asthma control in real-time; (3) simplify insurance reimbursement by documenting patient education; (4) meet the requirements of meaningful use of technology in practice for Medicare and Medicaid EHR incentive programs; and (4) provide third party vendors with Non-PHI Data for marketing and other business intelligence purposes.

The System 116 may reside on an Application Server 118, and communication of information between Users and the Application Server 118 occurs through a Communications Network 114. In various embodiments, the Communication Network 114 also communicates information between the System 116 and any Third Party Data Server 120.

The Third Party Data Server 120 may be a HIPAA and HITECH-compliant cloud storage service such as Catalyze, capable of storing Data 112, regardless of whether such Data 112 is PHI Data or Non-PHI Data.

The Third Party Data Server 120 may include a plurality of databases within which PHI and Non-PHI Data may be stored. The System 116 stores data uploaded by a Patient User 106 or Practice User 104 within a PHI Database 122 located on the Third Party Data Server 120.

In one embodiment, the System 116 uses an algorithm to strip PHI Data stored in a PHI Database 122 of any of its personally identifiable information, in which case it is no longer considered “PHI”, but rather Non-PHI Data. In one embodiment, the System 116 may store this Non-PHI Data in a Non-PHI Database 124, which may or may not be located on a Third Party Data Server 120, but in any event will not be stored with any PHI Data.

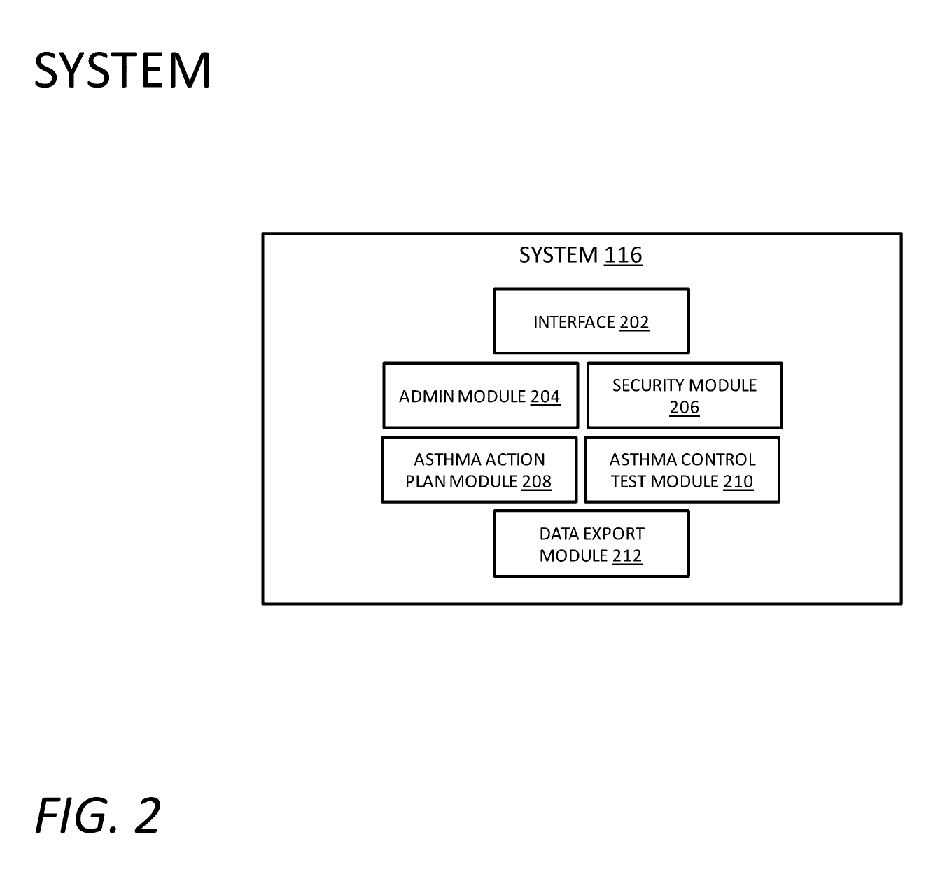

Referring now to FIG. 2, one embodiment of a high level architecture for the System 116 is shown. In one embodiment, the System 116 may include an Interface 202, an Admin Module 204, a Security Module 206, an Asthma Action Plan Module 208, an Asthma Control Test Module 210, and a Data Export Module 212.

The Interface 202 provides methods for Users to interact with the various modules of the System 116. The Interface 202 may consist of a hypertext markup language (HTML) interface or a software application that may include a graphical user interface (“GUI”) that runs on the browser or computer of a User. The Interface 202 may allow for data entry, point/click, and drag/drop. The Interface 202 may also provide the User with resulting textual and graphical output and provide visual alerts or indications.

Modules 204-212 of the System 116 are described in greater detail below.

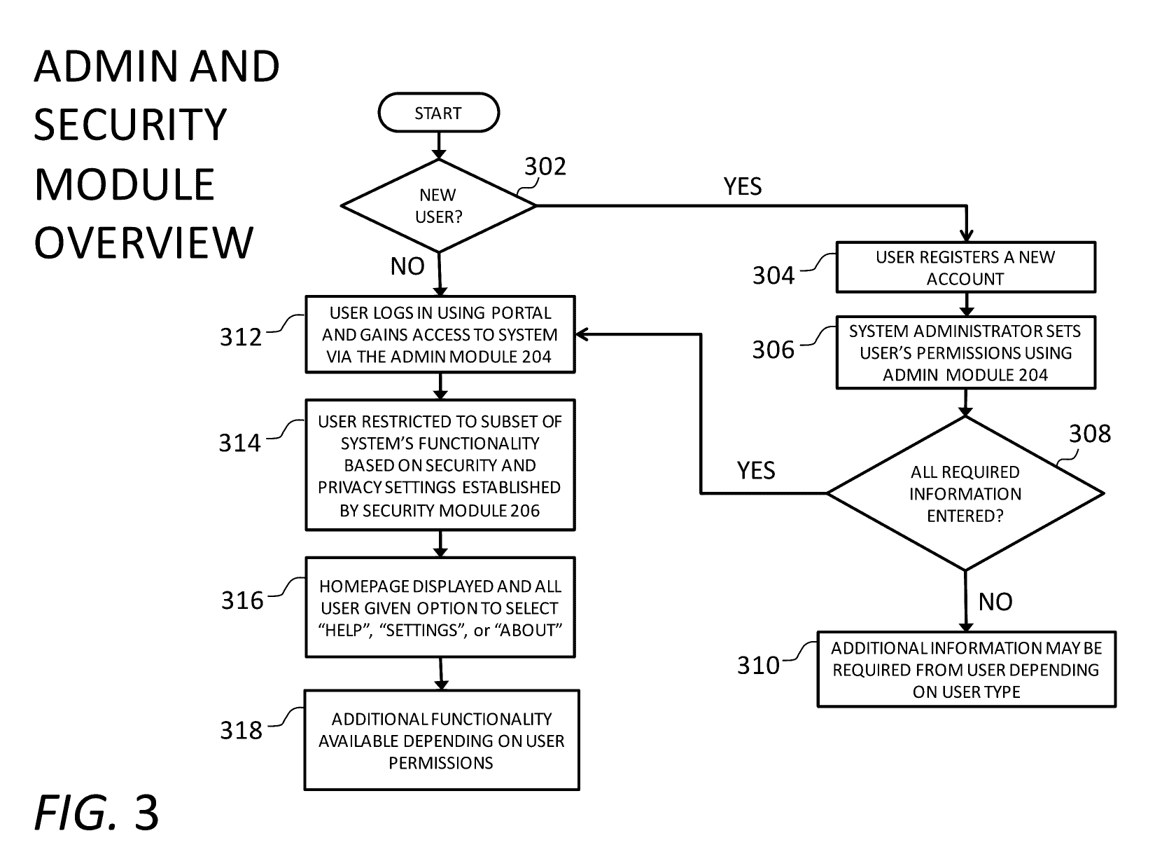

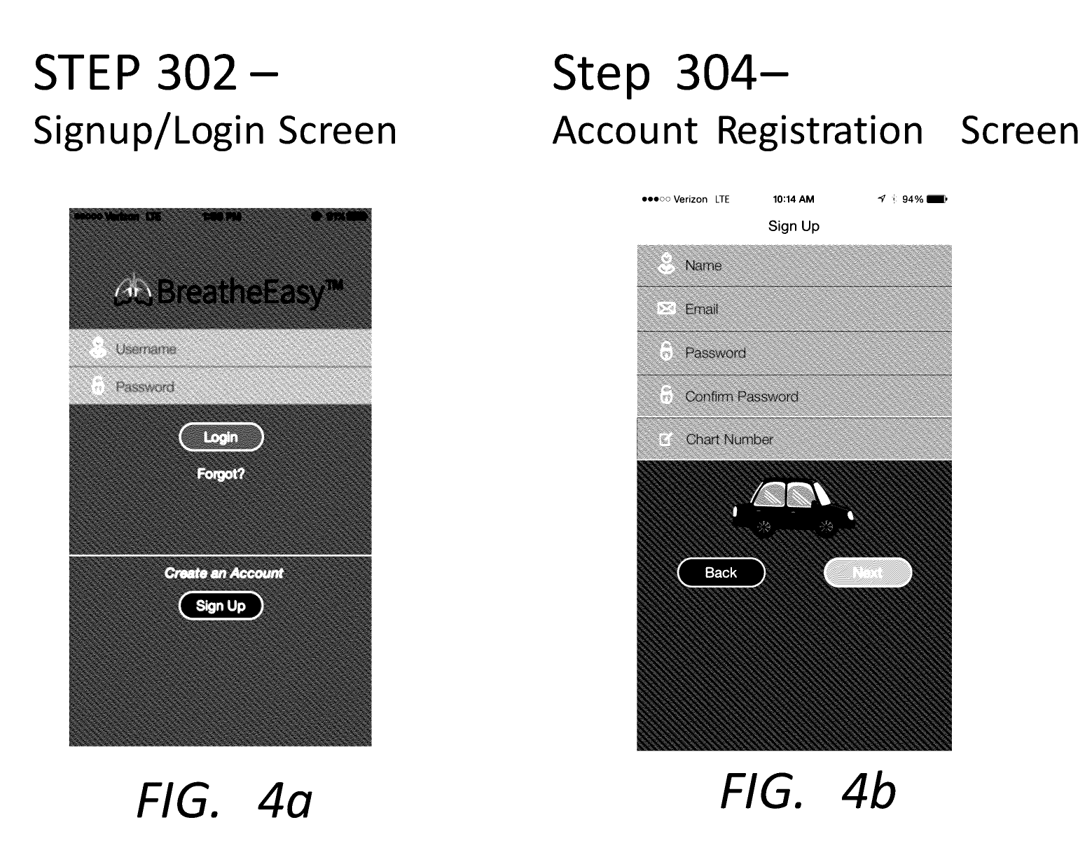

Referring now to FIG. 3, a high level flow chart illustrating the various functions of the Admin Module 204 and Security Module 206 of the system is shown. The Admin Module 204 controls authorization and access to the System 116. At Step 302, a User gains access to the System 116 via the Interface 202. Step 302 is further illustrated by the “Signup/Login” screenshot of FIG. 4a. Users that have not previously logged on to the System 116 will proceed through Steps 310, while existing Users will use the Interface to login to the System 116 using an email and password at Step 312.

At Step 304 a User may register a new account by providing some basic information such as name, email address, and password, as illustrated by the “Account Registration” screenshot shown on FIG. 4b. The user's account and user's basic information are stored on the Application Server 118.

At Step 306 a system administrator uses the Admin Module 204 to assign user permissions to each User that registers a new account. In one embodiment, a system administrator may interact with the Admin Module 204 through the Interface 202 to configure external connections, as well as to add or modify a User. In another embodiment, access to the System 116 may be provided by the Admin Module 204 through a portal or web services.

At Step 308, based on requirements set by the system administrator, the Admin Module 202 determines whether all required information has been entered by the new User. Certain types of Users may require additional information in order to establish a new account. By way of example only, a Patient User 106 may be prompted at Step 310 to enter a chart number assigned to them by a Healthcare Provider 102.

At Step 312 existing Users log on to the System 116 using the email and password with which they registered an account at Step 304.

At Step 314 the Security Module 206 restricts User access to appropriate subsets of functionality within the System 116 based on data security and privacy guidelines contained within the Security Module 206.

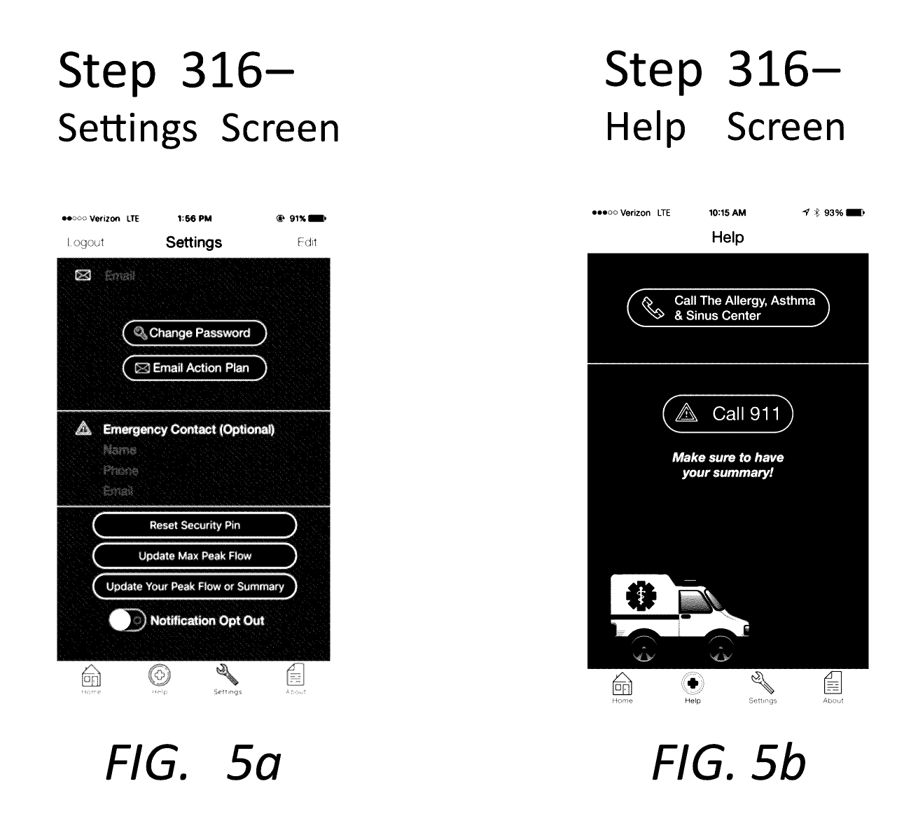

At Step 316 Users may select any number of options from the application's homepage, including options for “Settings,” “Help,” and “About.” FIG. 5a shows a screenshot of the “Settings” screen. In one embodiment, a Patient User 106 may change their password, or edit their emergency contact or doctor's information using the Interface 202 and the “Settings” screen.

FIG. 5b shows a screenshot of the “Help” screen. In one embodiment, Patient Users 106 may call, in case of an emergency, 911 or their healthcare provider's office by selecting via the Interface 202 which number they wish the System 116 to automatically dial.

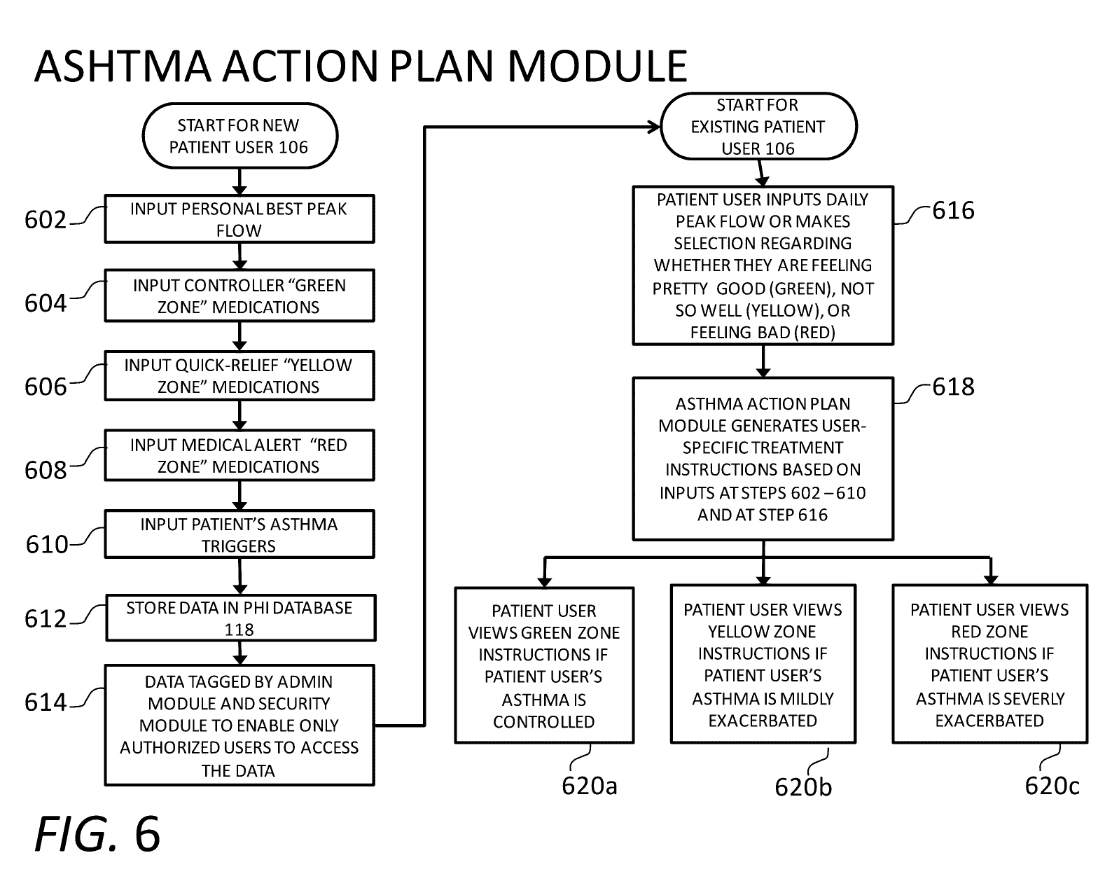

Referring now to FIG. 6, a high level flow chart illustrating the various functions of the Asthma Action Plan Module 208 is shown. The Asthma Action Plan Module 208 enables a Patient User 106 to view a copy of the asthma action plan prescribed to them by their Healthcare Provider 102. In one embodiment, a Practice User 104 inputs certain prescribed medications into the System 116 for viewing by a Patient 106 at a time or times of their choosing. In providing an easily-accessible copy of a patient's asthma action plan, the Asthma Action Plan Module improves patient outcomes by increasing the rate of asthma action plans prescribed to patients during office visits, improves patient access to asthma action plans at the time of an exacerbation, and improves upon the functionality of written asthma action plans currently in place.

Steps 602 through 614 are intended as initial steps that, in at least one embodiment, must be completed by a Patient User 106 in conjunction with a Practice User 104 pursuant to a prescription or prescriptions being written by an authorized agent of a Healthcare Provider 102. These initial steps must be completed to import the Patient User 106's prescribed asthma action plan into the System 116 so that it might later be viewed by a Patient User 106, as demonstrated by Steps 616 through 620c.

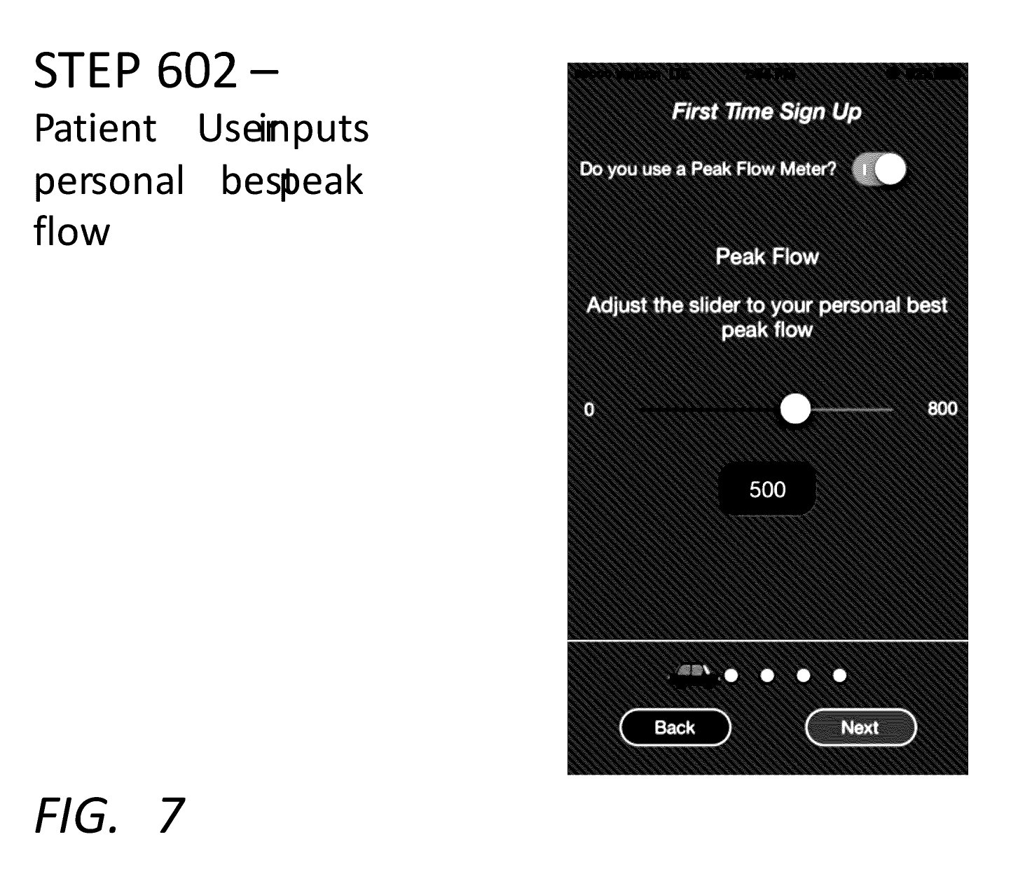

At Step 602 a new Patient User 106 inputs their personal best peak flow. This step is further illustrated by a screenshot of the Interface 202 displaying the “Personal Best Peak Flow” screen as shown by FIG. 7.

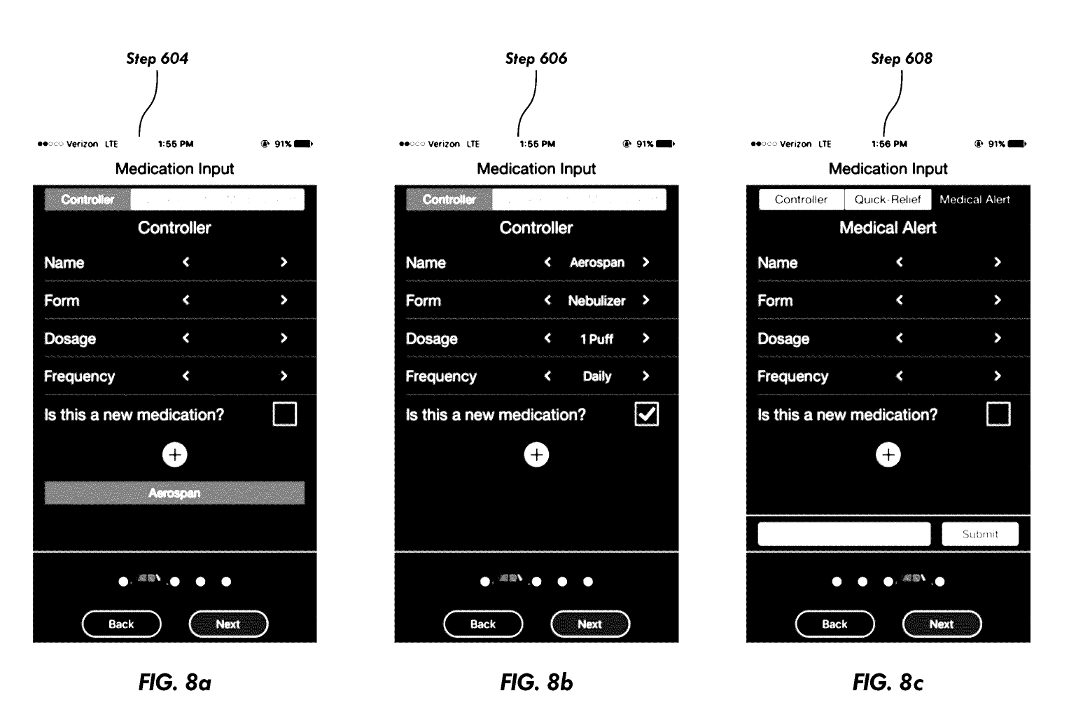

At Step 604 a Practice User 104 inputs the Patient User 106's controller, or “Green Zone” medication(s), if any, as prescribed by an authorized agent of the Healthcare Provider 102. This step is further illustrated by a screenshot of the Interface 202 displaying the “Green Zone Medication Input” screen as shown by FIG. 8a.

At Step 606 a Practice User 104 inputs the Patient User 106's quick-relief, or “Yellow Zone” medication(s), if any, as prescribed by an authorized agent of the Healthcare Provider 102. This step is further illustrated by a screenshot of the Interface 202 displaying the “Yellow Zone Medication Input” screen as shown by FIG. 8b.

At Step 608 a Practice User 104 inputs the Patient User 106's medical alert, or “Red Zone” medication(s), if any, as prescribed by an authorized agent of the Healthcare Provider 102. This step is further illustrated by a screenshot of the Interface 202 displaying the “Red Zone Medication Input” screen as shown by FIG. 8c.

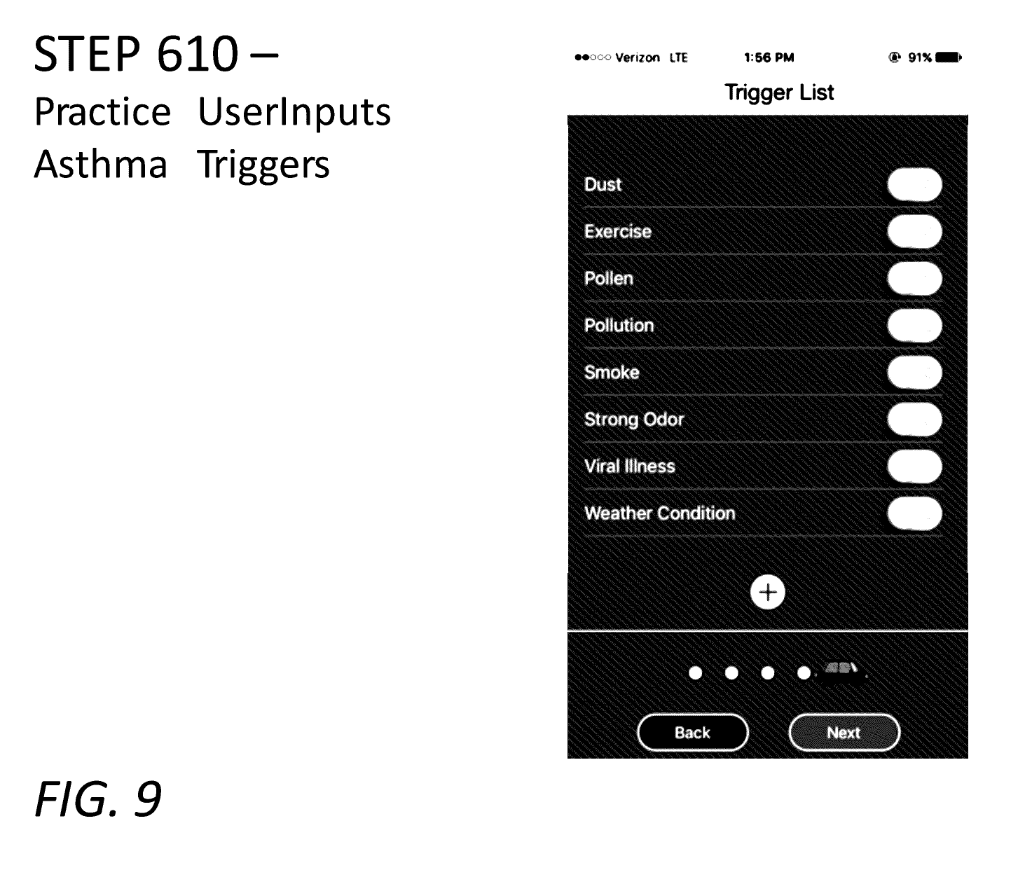

At Step 610 a Practice User 104 inputs the Patient User's asthma triggers. In another embodiment, the Patient User 106 inputs asthma triggers or updates the list of asthma triggers entered by a Practice User 104. This step is further illustrated by a screenshot of the Interface 202 displaying the “Asthma Triggers” screen as shown by FIG. 9.

At Step 612 the Asthma Action Plan Module 208 stores the Data 112 input by the Practice and Patient Users at Steps 602 through 610 in a HITECH and HIPAA-compliant, PHI Database 122 residing on a Third Party Data Server 120. In one embodiment, Data 112 input by the Practice and Patient Users at Steps 602 through 610 contains both PHI Data, as well as Non-PHI Data. In such an instance, the Asthma Action Plan Module stores all of the Data 112, including the Non-PHI Data, in a HITECH and HIPAA-compliant, PHI Database 122.

Once all the information required at Steps 602 through 610 has been entered and stored on a PHI Database 122, it is tagged at Step 614 by the Admin Module 204 and Security Module 206 to enable access only to a restricted subset of authorized Users.

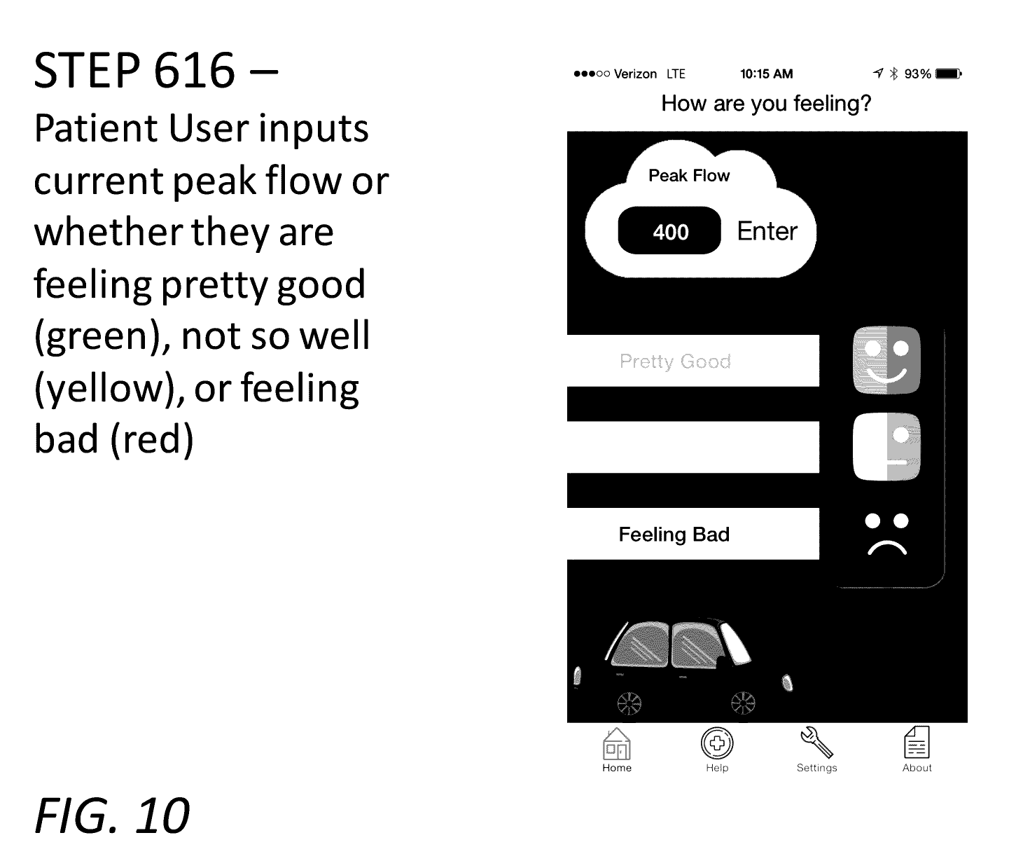

At Step 616 a Patient User 106 has the option to enter either their peak flow reading for that particular day or timeframe, or to make a selection regarding how they feel on that particular day or during that particular timeframe. In one embodiment, the Interface will display an input box for the Patient User's current peak flow reading, as well as “green,” “yellow,” and “red” icons so that the patient may indicate how they are feeling with regard to their asthma symptoms. This step is further illustrated by a screenshot of the Interface 202 displaying the “How Are You Feeling?” screen as shown by FIG. 10.

In an alternative embodiment, input from a peak flow meter will be measured from a peak flow meter device in electronic communication with a user device, such as a mobile phone, and automatically entered into the Interface. The data from the peak flow meter measurement may be transmitted and stored on the PHI Database 122. The Asthma Action Plan Module 208 analyzes the peak flow meter measurement and may automatically prescribe instructions based on a value of the peak flow meter measurement according to the patient's Asthma Action Plan as discussed in further detail below.

In one embodiment, the Asthma Action Plan Module 208 generates user-specific treatment instructions at Step 618 depending upon the input of the Patient User 106 at Step 616 and the Patient User's prescribed asthma action plan as entered into the system at Steps 602 through 610.

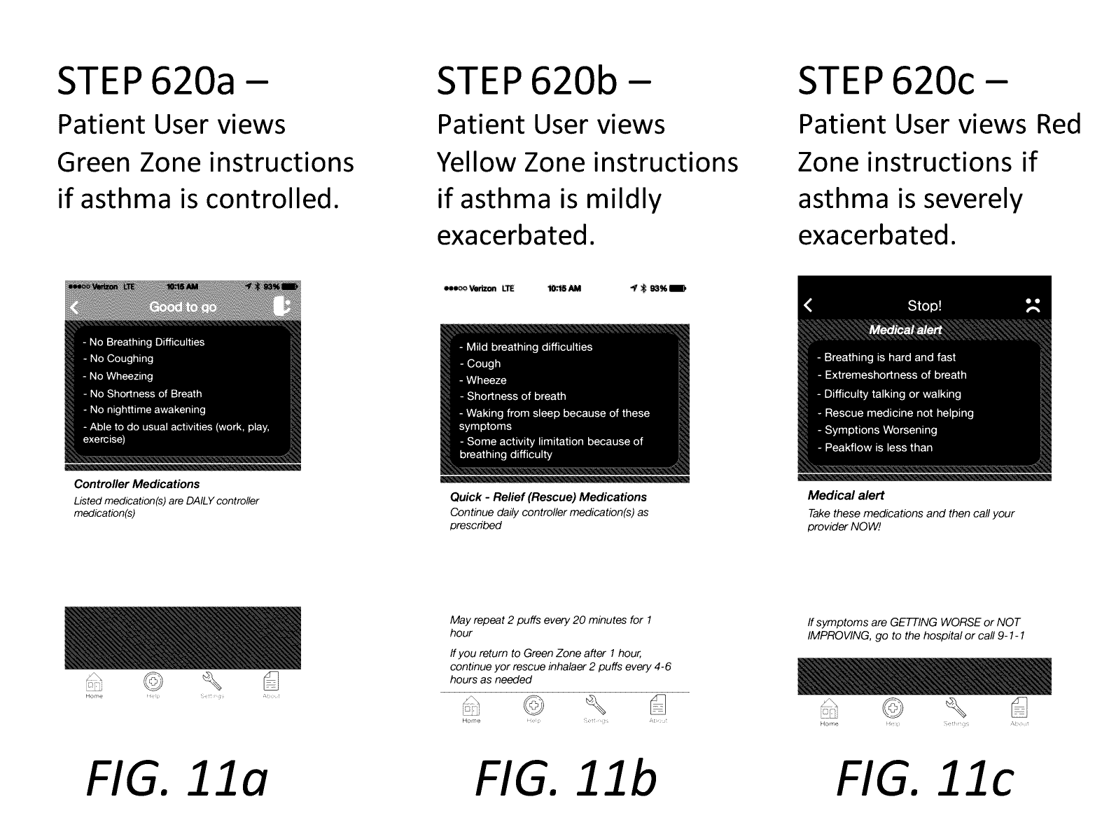

At Step 620 a Patient User 106 may view the user-specific treatment instructions generated at Step 618. Depending on the inputs at Steps 602-610 and at Step 616, a Patient User 106 will be prompted to view either “Green Zone Instructions” at Step 620a, “Yellow Zone Instructions” at Step 620b, or “Red Zone Instructions” at 620c. By way of example only, a Patient User 106 whose asthma is controlled will be prompted to view the “Green Zone Instructions” as prescribed to them by their doctor, while a Patient User 106 whose asthma is mildly exacerbated will be prompted to view their doctor-prescribed “Yellow Zone Instructions,” and a Patient User 106 whose asthma is severely exacerbated will be prompted to view their doctor-prescribed “Red Zone Instructions.” These alternate steps are further illustrated by screenshots of the Interface 202 displaying the “Green,” “Yellow,” and “Red Zone Instructions” screens as shown by FIGS. 11a, 11b, and 11c, respectively.

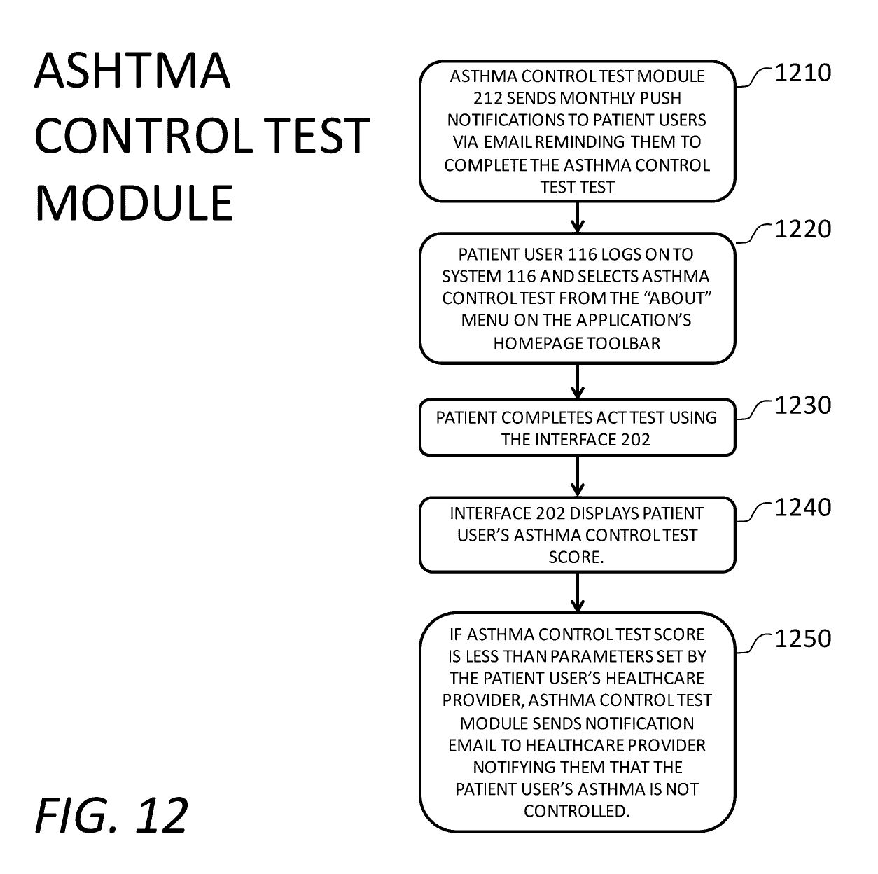

Referring now to FIG. 12, a high level flow chart illustrating the various functions of the Asthma Control Test Module 210 is shown. The Asthma Control Test Module 210 enables a Patient User 106 to complete an asthma control test to determine whether their asthma is controlled, or whether a Patient User's asthma control test score warrants that a notification email be sent by the Asthma Control Test Module 210 to the Healthcare Provider 102 responsible for prescribing the Patient User 106's asthma action plan. Asthma control tests are commonly administered during office visits by healthcare providers to determine whether a patient's asthma is being controlled. In one embodiment, the Asthma Control Test Module 210 enables Patient Users 106 to complete an asthma control test as often as they would like, or upon prompting by a notification email sent as described below.

As referred to herein, an asthma control test refers to a test for a patient user to enter information regarding the Patient User's current asthma symptoms and history of asthma symptoms to determine whether a Patient′ User's asthma symptoms are under control.

At Step 1210 the Asthma Control Test Module 210 sends a push notification email to the email address provided by and authorized for use by a Patient User 106. In one embodiment, this notification email would contain a link pointing to the System 116's “Signup/Login” screen as illustrated by FIG. 4a.

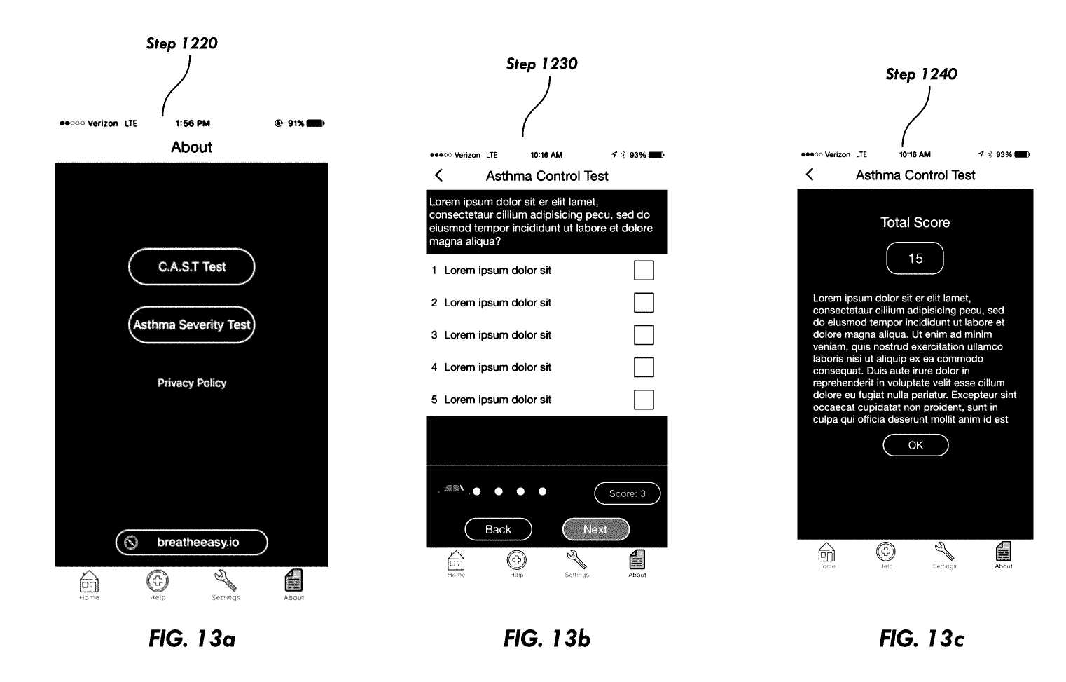

At Step 1220 a Patient User 106 logs on to the System 116 via the application's “Signup/Login” screen and selects the “About” page from the application's homepage toolbar once logged on. This step is further illustrated by a screenshot of the Interface 202 displaying the “Launch” screen as shown by FIG. 13a, which is displayed upon the Patient User selecting the “About” page.

Using the Interface 202, a Patient User completes an asthma control test at Step 1230, as illustrated by a screenshot of the Interface 202 displaying the “Test” screen as shown by FIG. 13b.

At Step 1240, the asthma control test score of the Patient User 106 is displayed via the Interface 202, as illustrated by a screenshot of the Interface 202 displaying the “Score” screen as shown by FIG. 13c.

In one embodiment, at Step 1250 the Asthma Control Test Module 210 sends a notification to the Healthcare Provider 102 of a Patient User 106, but only if such user's score is below a certain threshold. In one embodiment, the notification email will show the Healthcare Provider 102 the name, chart number, email address, and phone number of the Patient User 106 that failed the asthma control test. In other embodiments, the notification email may contain a link or links allowing for a Healthcare Provider 102 to automatically call or email a Patient User 106 to schedule an appointment once notified of that user's failure of the asthma control test. In another embodiment, a Healthcare Provider 102 may establish asthma control test parameters, such as a pass/fail threshold and specific questions to be asked of a Patient User 106. In such an instance, these parameters would be input by a Practice User 104 using the Interface 202 to adjust the Settings for a Practice User 104 acting on behalf of a Healthcare Provider 102.

In one embodiment, the Asthma Action Control Test Module 210 is a Classifying Asthma Severity Test that assigns a score to the patient user based on responses to prompt's that are displayed to the patient user. Prompts are displayed to the Patient User through the Interface 202 along with a plurality of patient user selectable responses that correspond to symptoms of the Patient User's asthma. Each of the patient user selectable responses may be assigned a value, and an overall score of the patient user's asthma control determined based on the patient user selected responses.

As one example, the Classifying Asthma Severity Test of the Asthma Action Control Test module 210 may include at least the following prompts and patient user selectable responses and point values:
1. In the last 7 days, how many times did your asthma symptoms require you to use your rescue medicine (inhaler or nebulizer)?
   a. <2 times (0 points)
   b. >2 times but <7 times (1 point)
   c. >Daily (2 points)
   d. >More than once per day (3 points)
2. During the last 7 days, how sever were your asthma symptoms?
   a. No asthma symptoms during the lats week (0 points)
   b. Mid impairment in normal activity; mild shortness of breath, coughing, or wheezing (1 point)
   c. Impacted normal activity; had to slow down due to symptoms (2 points)
   d. Sever impairment; could not complete full sentences at times (3 points)
3. During the last 7 days, did you experience asthma symptoms (coughing, wheezing, shortness of breath) that woke you from sleep?
   a. No (0 points)
   b. Yes, but only once (1 point)
   c. Yes, 2-3 times (2 points)
   d. Yes, almost every night (3 points)
4. How many of the following asthma symptoms are you currently experiencing (coughing/wheezing, shortness of breath, tightness in chest)?
   a. None of these symptoms (0 points)
   b. One of these symptoms (1 point)
   c. Two of these symptoms (2 points)
   d. All of these symptoms (3 points)

In one embodiment, the System prompts the Patient User via a notification such as a push notification on a device of the Patient User to complete the Classifying Asthma Severity Test on a period basis, such as weekly or monthly. The System may further prompt the Patient User to take medication to control asthma symptoms of the Patient User with a notification on a device of the Patient User. A medication reminder may remind a Patient User to take medication at prescribed dosages and intervals.

In another embodiment, the System 116 may generate and associate various rewards or badges with a Patient User profile based on the Patient User's repeated testing and monitoring of asthma symptoms. For example, badges or awards may be issued to a Patient User's profile if the Patient User successfully and timely completes Classifying Asthma Severity Tests when prompted by the System to complete the tests.

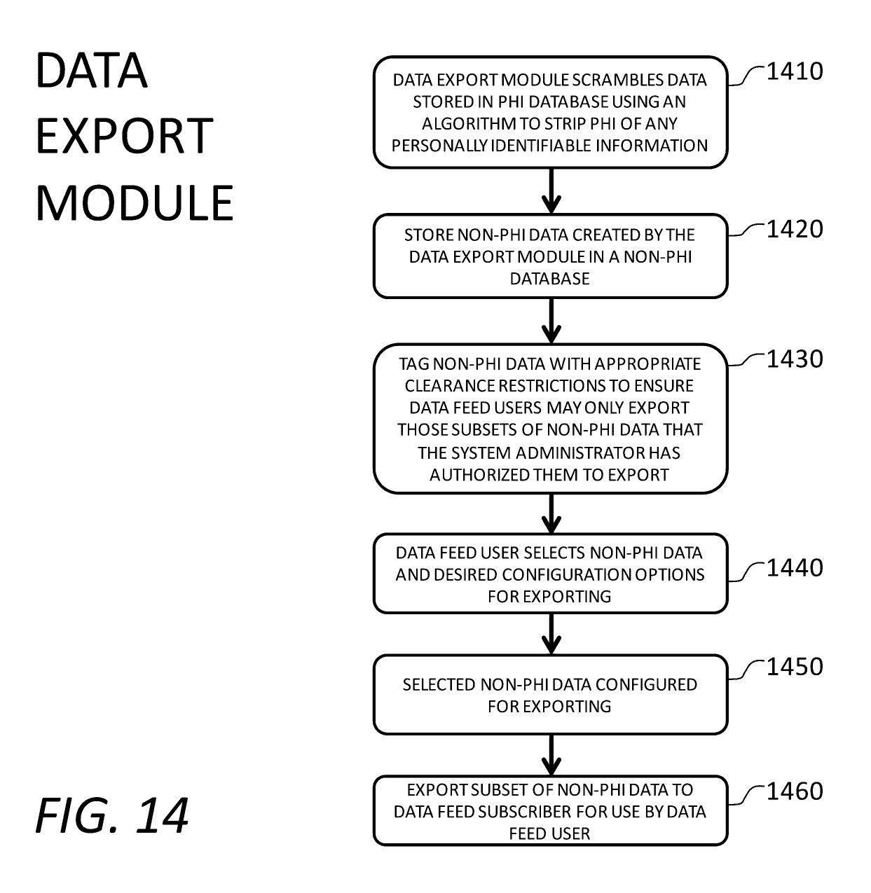

Referring now to FIG. 14, a high level flow chart illustrates the functions of the Data Export Module 212. In one embodiment, a Data Feed User 110 may wish to export Non-PHI Data for marketing or other business intelligence purposes, e.g., a pharmaceutical company may wish to export Non-PHI Data to determine such analytics as the number of new prescriptions of a particular drug that were refills versus those that were newly-written prescriptions.

At Step 1410 the Data Export Module 212 scrambles all or a subset of the Data 112 stored in the PHI-Database 122. In one embodiment, the Data Export Module 212 may use an algorithm to strip Data 112 stored in the PHI Database 122 of any personally identifiable health information that would necessitate HITECH or HIPAA compliance.

At Step 1420, the Data Export Module 218 stores any Non-PHI Data created at Step 1410 in a Non-PHI Database 124. In each possible embodiment, the Non-PHI Database would not store PHI data that would necessitate compliance with HIPAA or the HITECH Act. In one embodiment, the Non-PHI Database 124 may be stored on a HITECH and HIPAA Compliant Third Party Data Server 120, while in other embodiments, the Non-PHI Database 124 may be stored on a third party data server that is not HITECH or HIPAA Compliant. On the other hand, any Data 112 stored by the System 116 that contains PHI Data, will at all times be stored on a HITECH and HIPAA compliant, PHI Database 122 such as Catalyze, and all such data will be received, transmitted, created, manipulated, or exported by the System 116 in compliance with HITECH and HIPAA regulations.

At Step 1430 the Data Export Module 212 tags all of the Non-PHI Data created at Step 1420 with appropriate user permissions to ensure Users may only export those subsets of Non-PHI Data that they are authorized to do so. These user permissions would be controlled by a system administrator, and managed by the Admin Module 204 and Security Module 206 of the System 116.

At Step 1440 a Data Feed User 110 selects a subset of the Non-PHI Data in the Non-PHI Database 124 for exporting from the System 116, and chooses the desired configuration output of that data. In one embodiment, the Data Feed User 110 would only have the option to select those subsets of Non-PHI Data that that particular user account is authorized to do so based on its user permissions.

At Step 1450 the Data Export Module 212 configures the Non-PHI Data in the Non-PHI Database 124 based on the desired configuration output of a Data Feed User 110 selected at Step 1440.

At Step 1460 the Data Export Module 212 exports the Non-PHI Data selected at Step 1440 to another application or device selected by a Data Feed User 110 on behalf of a Data Feed Subscriber 108. For example, the Data Export Module 212 may send the exported Non-PHI Data to a spreadsheet or other data analytics application located on a Data Feed User's desktop workstation. In another embodiment, the Data Export Module 212 may send other Non-PHI Data selected by the Data Feed User 110 at Step 1440 to a printer for printing.

PHI and Non-PHI Data of the System may be stored or generated in a format that is compatible with existing electronic medical records (“EMR”) of healthcare providers, such as EPIC EMR or other types of EMR formats.

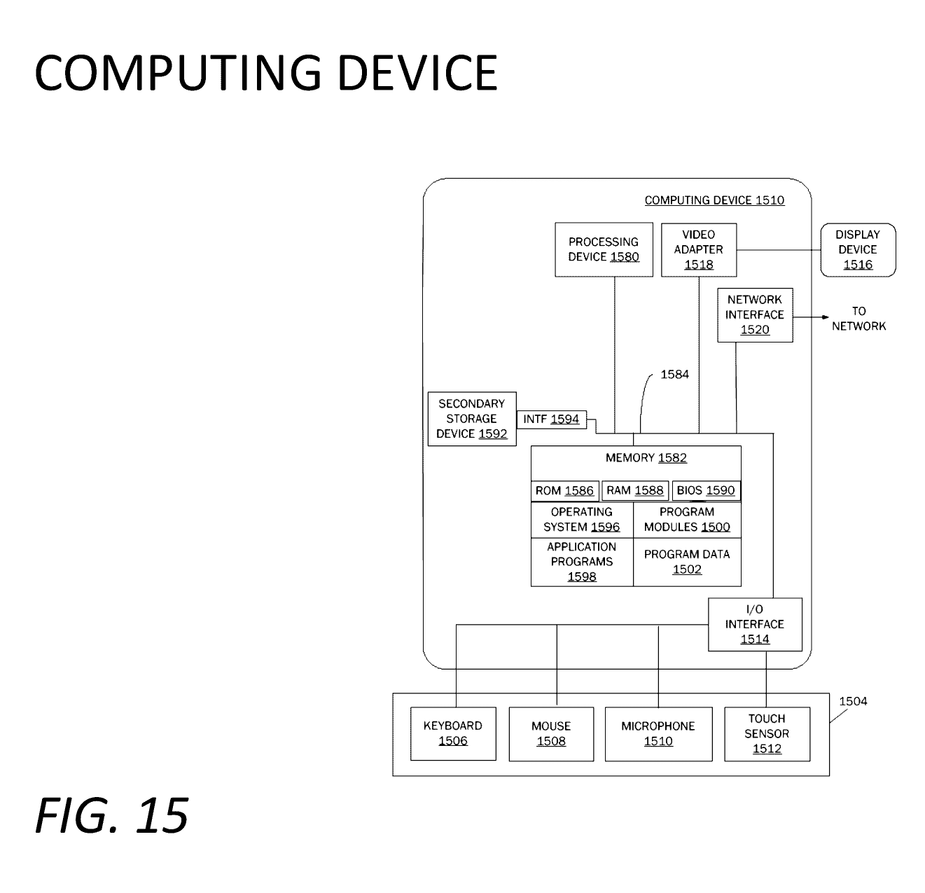

Referring now to FIG. 15, an exemplary architecture of a computing device that can be used to implement aspects of the present disclosure is illustrated. The computing device illustrated in FIG. 15 can be used to execute the operating system, application programs, and software modules (including the software engines) described herein.

The computing device 1510 includes, in some embodiments, at least one processing device 1580, such as a central processing unit (CPU). A variety of processing devices are available from a variety of manufacturers, for example, Intel or Advanced Micro Devices. In this example, the computing device 1510 also includes a system memory 1582, and a system bus 1584 that couples various system components including the system memory 1582 to the processing device 1580. The system bus 1584 is one of any number of types of bus structures including a memory bus, or memory controller; a peripheral bus; and a local bus using any of a variety of bus architectures.

Examples of computing devices suitable for the computing device 1510 include a desktop computer, a laptop computer, a tablet computer, a mobile computing device (such as a smart phone, a tablet device, or other mobile devices), or other devices configured to process digital instructions.

The system memory 1582 includes read only memory 1586 and random access memory 1588. A basic input/output system 1590 containing the basic routines that act to transfer information within computing device 1510, such as during start up, is typically stored in the read only memory 1586.

The computing device 1510 also includes a secondary storage device 1592 in some embodiments, such as a hard disk drive, for storing digital data. The secondary storage device 1592 is connected to the system bus 1584 by a secondary storage interface 1594. The secondary storage devices 1592 and their associated computer readable media provide nonvolatile storage of computer readable instructions (including application programs and program modules), data structures, and other data for the computing device 1510.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1592 or memory 1582, including an operating system 1596, one or more application programs 1598, other program modules 1500 (such as the software engines described herein), and program data 1502. The computing device 1510 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 1510 through one or more input devices 1504. Examples of input devices 1504 include a keyboard 1506, mouse 1508, microphone 1510, and touch sensor 1512 (such as a touchpad or touch sensitive display). Other embodiments include other input devices 1504. The input devices are often connected to the processing device 1580 through an input/output interface 1514 that is coupled to the system bus 1584. These input devices 1504 can be connected by any number of input/output interfaces, such as a parallel port, serial port, game port, or a universal serial bus. Wireless communication between input devices and the interface 1514 is possible as well, and includes infrared, BLUETOOTH® wireless technology, 802.11a/b/g/n, cellular, or other radio frequency communication systems in some possible embodiments.

In this example embodiment, a display device 1516, such as a monitor, liquid crystal display device, projector, or touch sensitive display device, is also connected to the system bus 1584 via an interface, such as a video adapter 1518. In addition to the display device 1516, the computing device 1510 can include various other peripheral devices (not shown), such as speakers or a printer.

When used in a local area networking environment or a wide area networking environment (such as the Internet), the computing device 1510 is typically connected to a network through a network interface 1520, such as an Ethernet interface. Other possible embodiments use other communication devices. For example, some embodiments of the computing device 1510 include a modem for communicating across the network.

The computing device 1510 typically includes at least some form of computer readable media. Computer readable media includes any available media that can be accessed by the computing device 1510. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1510.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 15 is also an example of programmable electronics, which may include one or more such computing devices, and when multiple computing devices are included, such computing devices can be coupled together with a suitable data communication network so as to collectively perform the various functions, methods, or operations disclosed herein.

The system of the present disclosure advantageously encourages patients to follow an asthma action plan and further provides a customized asthma action plan to the patient based on that patient's current asthma symptoms. Patients are able to quickly enter information, such as a peak flow rate or other data related to the patient's asthma symptoms, and the system will generate suggested actions for the patient based on the experienced symptoms. Healthcare providers may update the patient's action plan and be alerted in real-time when the patient is experience problematic or dangerous asthma symptoms. The system may also aggregate and remove personal identifying information from data collected from patient's by the system for further analysis.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A system for prescribing a real-time asthma action plan to a patient, the system comprising:
a database having at least one processor and at least one computer readable storage medium in communication with the processor;
instructions stored on the at least one computer readable storage medium for implementing a plurality of modules for prescribing an asthma action and control plan, the plurality of modules comprising:
an interface module including a graphical user interface for providing visual and textual information to and receiving data entry input from a plurality of users;
an asthma action plan module that
receives data regarding a patient user's best peak flow measurement from the patient user through the interface module;
receives data regarding any controller zone, quick relief zone, and alert zone medications of the patient user from a healthcare provider user;
receives data regarding asthmatic triggers of the patient from the healthcare provider user;
stores data received from the patient user and the healthcare provider user on a healthcare information database;
receives data regarding a patient user's current respiratory condition from the patient user through the interface module;
generates patient user specific instructions based on the received data regarding the patient's user's best peak flow measurement and healthcare provider user medication data in response to the patient user's current respiratory condition; and
displays the generated patient user specific instructions to the patient on the interface module.

2. The system of claim 1 further comprising a classifying asthma severity test module that
displays a plurality of prompts to the patient user regarding asthma symptoms of the patient user;
displays a plurality of patient user selectable responses to the plurality of prompts to the patient user on the interface module;
receives data regarding responses to the plurality of prompts selected by the patient user;
stores data related to the plurality of received responses to the plurality of prompts selected by the patient user;
assigns each of the plurality of received responses a value based on a severity of the patient user's asthma symptoms;
generates a classifying asthma severity test score based on the values of the plurality of received responses of the patient user; and
displays the generated classifying asthma severity test score to the patient user on the interface module.

3. The system of claim 2, wherein the classifying asthma severity test module transmits a notification to the healthcare provider user regarding a status of the patient user's asthma symptoms when the generated classifying asthma severity test score is beyond a designated threshold.

4. The system of claim 2, wherein the classifying asthma severity test module generates a periodic notification that is transmitted to the patient user to perform a test of the patient user's asthma severity.

5. The system of claim 2, wherein the plurality of prompts displayed to the patient user correspond to a number of times that the patient user's asthma symptoms required use of a medicine, a level of severity of asthma symptoms of the patient user, whether the patient user experienced symptoms that awoke the patient user from sleep, and a number of current asthma symptoms being experienced by the patient user.

6. The system of claim 1, further comprising a peak flow meter in electronic communication with the database, wherein data regarding the patient user's current respiratory condition is received from the peak flow meter and stored on the healthcare information database.

7. The system of claim 6, wherein data regarding the patient user's current respiratory condition is transmitted to the healthcare provider user.

8. The system of claim 1 further comprising a data export module that
generates non-personally identifiable healthcare data by removing identifiable information from the patient user data from the patient user data stored on the healthcare information database; and
stores non-personally identifiable healthcare data on a non-personally identifiable healthcare information database.

9. The system of claim 8, wherein the non-personally identifiable healthcare data is tagged with one or more clearance restrictions that designate authorized data feed users.

10. The system of claim 9, wherein the data export module exports non-personally identifiable healthcare data to authorized data feed users in response to a request for healthcare data from the data feed users.

11. A system for prescribing a real-time asthma action plan to a patient, the system comprising:
a database having at least one processor and at least one computer readable storage medium in communication with the processor;
instructions stored on the at least one computer readable storage medium for implementing a plurality of modules for prescribing an asthma action and control plan, the plurality of modules comprising:
an interface module including a graphical user interface for providing visual and textual information to and receiving data entry input from a plurality of users;
an asthma action plan module that
receives data regarding a patient user's best peak flow measurement from the patient user through the interface module;
receives data regarding any controller zone, quick relief zone, and alert zone medications of the patient user from a healthcare provider user;
receives data regarding asthmatic triggers of the patient from the healthcare provider user;
stores data received from the patient user and the healthcare provider user on a healthcare information database;
receives data regarding a patient user's current respiratory condition from the patient user through the interface module;
generates patient user specific instructions based on the received data regarding the patient's user's best peak flow measurement and healthcare provider user medication data in response to the patient user's current respiratory condition; and
displays the generated patient user specific instructions to the patient on the interface module
a classifying asthma severity test module that
displays a plurality of prompts to the patient user regarding asthma symptoms of the patient user;
displays a plurality of patient user selectable responses to the plurality of prompts to the patient user on the interface module;
receives data regarding responses to the plurality of prompts selected by the patient user;
stores data related to the plurality of received responses to the plurality of prompts selected by the patient user;
assigns each of the plurality of received responses a value based on a severity of the patient user's asthma symptoms;
generates a classifying asthma severity test score based on the values of the plurality of received responses of the patient user; and
displays the generated classifying asthma severity test score to the patient user on the interface module.

12. A method for generating a real-time asthma action plan to a patient comprising:
receiving data regarding a patient user's best peak flow measurement from the patient user on a database;
receiving data regarding any controller zone, quick relief zone, and alert zone medications of the patient user from a healthcare provider user on the database;
receiving data regarding asthmatic triggers of the patient from the healthcare provider user on the database;
receiving data regarding a patient user's current respiratory condition from the patient user on the database;
generating patient user specific instructions based on the received data regarding the patient's user's best peak flow measurement and healthcare provider user medication data in response to the patient user's current respiratory condition; and
displaying the generated patient user specific instructions to the patient on a patient device.

13. The method of claim 12, further comprising:
displaying a plurality of prompts to the patient user regarding asthma symptoms of the patient user;
displaying a plurality of patient user selectable responses to the plurality of prompts to the patient user on the interface module;
receiving data regarding responses to the plurality of prompts selected by the patient user;
storing data related to the plurality of received responses to the plurality of prompts selected by the patient user;
assigning each of the plurality of received responses a value based on a severity of the patient user's asthma symptoms;
generating a classifying asthma severity test score based on the values of the plurality of received responses of the patient user; and
displaying the generated classifying asthma severity test score to the patient user on the interface module.
